(19) United States
(12) Patent Application Publication
(10) Pub. No.: US 2011/0253647 A1
(43) Pub. Date: Oct. 20, 2011

(54) RACK APPARATUS AND CABLE MANAGEMENT STRUCTURE THEREOF

(75) Inventors: MO-MING YU, Shenzhen City (CN); WEN-FENG HU, Shenzhen City (CN); ZE-HONG CHEN, Shenzhen City (CN)

(73) Assignees: HON HAI PRECISION INDUSTRY CO., LTD., Tu-Cheng (TW); HONG FU JIN PRECISION INDUSTRY (ShenZhen)CO., LTD., Shenzhen City (CN)

(21) Appl. No.: 12/787,338

(22) Filed: May 25, 2010

(30) Foreign Application Priority Data
Apr. 16, 2010 (CN) 201010148824.5

(51) Int. Cl. F16L 3/08; A47B 81/00

(52) U.S. Cl. 211/26; 248/70

(57) ABSTRACT

A rack apparatus includes a pair of opposite first and second slide assemblies, and a cable management structure disposed between the pair of slide assemblies. The cable management structure includes a supporting member with two ends thereof pivotally connected to two first movable rails of the pair of slide assemblies, and an arm assembly supported on the supporting member. The arm assembly includes a foldable main body, and first and second fixing members. Two ends of the main body of the arm assembly are pivotally connected to a stationary rail and a second movable rail of the first slide assembly via the first and second fixing members. The supporting member is slidable with the first movable rails of the two slide assemblies, and supports a portion of the main body of the arm assembly thereon during the spreading open and folding processes of the main body of the arm assembly.

### BACKGROUND

### 1. Technical Field

The disclosure generally relates to rack apparatuses for supporting electronic devices; and more particularly to a rack apparatus incorporating a cable management structure.

Commonly used rack apparatuses often include a pair of opposing sides to which telescoping slide assemblies are connected for slidable support of electronic devices, such as servers. Typically, multiple devices are disposed at different vertically-spaced levels in the rack apparatus, usually at close proximity to each other. Cables are extended from the electronic devices for connection outside the rack apparatus.

A cable management structure is provided for supporting the cables of each of the electronic devices in the rack apparatus. The cable management structure often includes two arms pivotally connected end to end. Opposite free ends of the cable management structure are respectively attached to a stationary rail and a movable rail of one of the slide assemblies. Accordingly, the cable management structure spreads open with the extension of the slide assembly, and collapses with the retraction of the slide assembly. Since the cable management structure cantilevers from the slide assembly, sagging due to weight of the cables can occur, thus negatively affecting the operation of an adjacent electronic device thereunder.

What is needed, therefore, is a cable management structure to overcome the above-described limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an assembled view of the rack apparatus for supporting electronic devices in accordance with an exemplary embodiment of the present disclosure.

FIG. 2 is an exploded, isometric view of the rack apparatus of FIG. 1.

FIG. 3 is similar to FIG. 2, but view from a different aspect.

FIG. 4 is an enlarged view of a circled portion IV of FIG. 2.

FIG. 5 is an inverted view of FIG. 1.

FIG. 6 is a top plan view of FIG. 1, showing a cable management structure of the rack apparatus fully folded.

FIG. 7 is similar to FIG. 6, but showing the cable management structure of the rack apparatus partially spread open.

FIG. 8 is similar to FIG. 6, but showing the cable management structure of the rack apparatus fully spread open.

### DETAILED DESCRIPTION

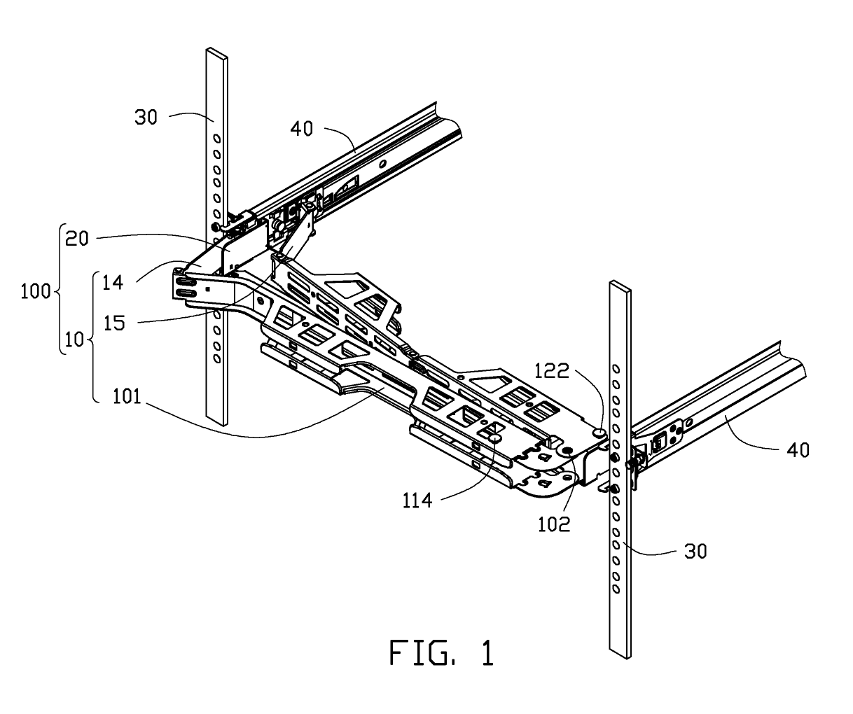

Referring to FIG. 1, a rack apparatus according to an exemplary embodiment of the present disclosure is shown. The rack apparatus includes a plurality of supporting posts 30 arranged in two parallel rows, two opposite slide assemblies 40 (i.e., a left slide assembly 40 and a right slide assembly 40), and a cable management structure 100 disposed between the two opposite slide assemblies 40. The two opposite slide assemblies 40 are horizontally mounted on the supporting posts 30, and spaced from each other, for slidable support of an electronic device (not shown), namely, a server, a power supply, or any other suitable device having cable attachments thereto. The cable management structure 100 is used for supporting and managing cables of the electronic device. The cable management structure 100 includes an arm assembly 10 and a supporting member 20.

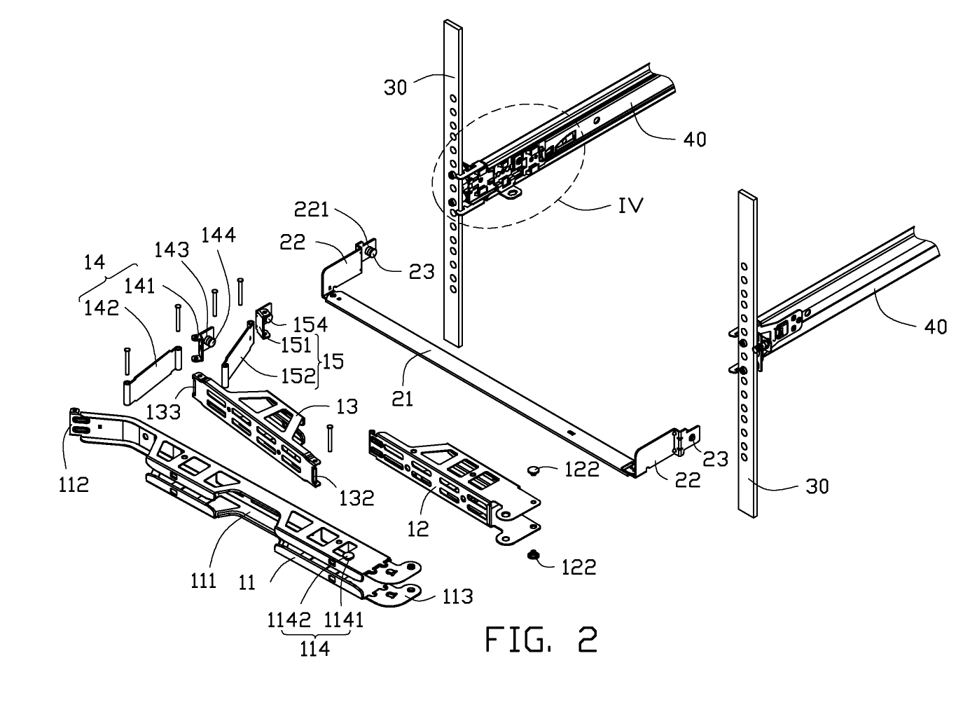

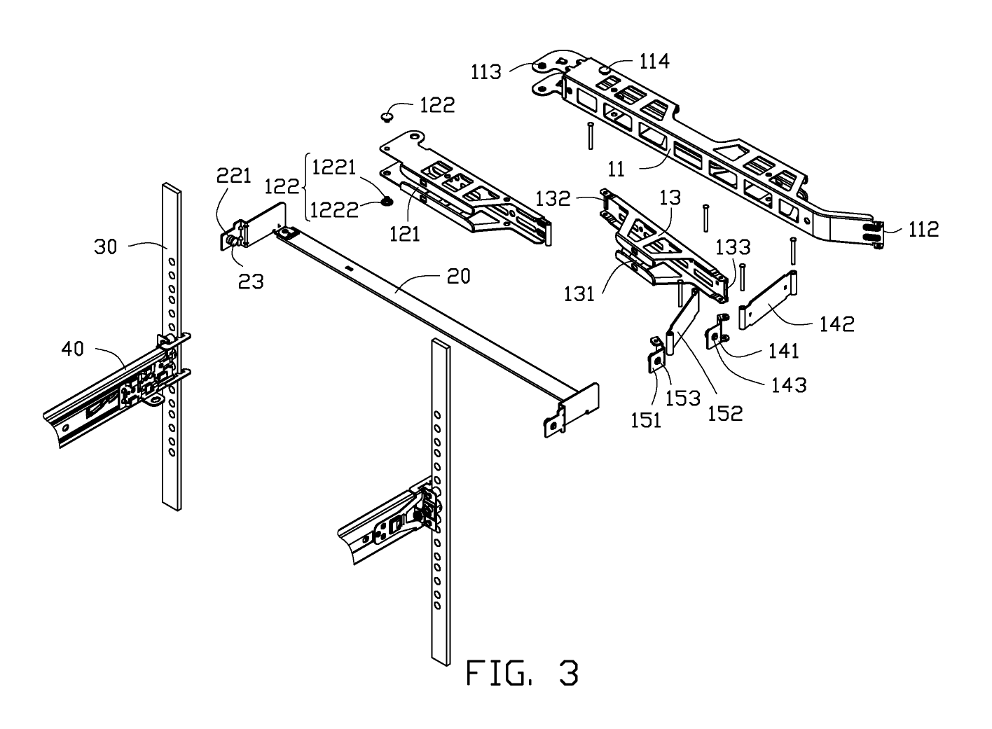

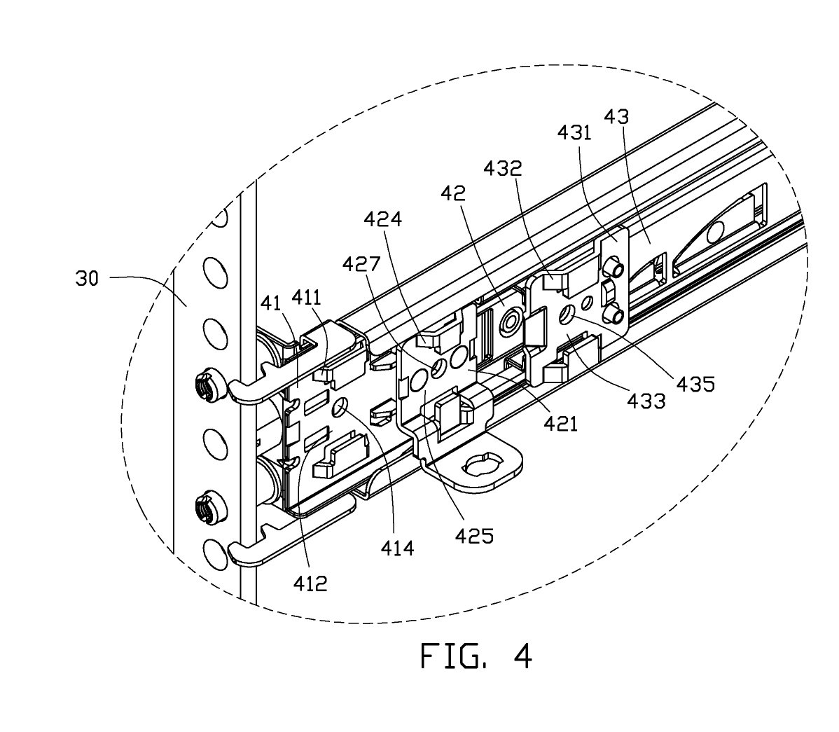

Referring also to FIGS. 2-4, each slide assembly 40 includes an outer stationary rail 41 and a first movable rail 42 in the middle, and a second movable rail 43 on the inside (see particularly in FIG. 4). The stationary rail 41 of one slide assembly 40 has a C-shaped cross section, and an opening facing the opposite slide assembly 40. The first movable rail 42 and the second movable rail 43 are slidably received in the stationary rail 41.

The stationary rail 41 forms two bow-shaped blocking pieces 411 thereon adjacent to a rear end thereof, and defines a locking hole 414 therein adjacent to the rear end thereof. The two blocking pieces 411 are respectively located at the top and bottom sides of the locking hole 414, and cooperatively bounding a guiding slot 412. Since each of the blocking pieces 411 includes a larger middle portion and two smaller end portions at the front and rear sides of the larger middle portion.

A locking plate 421 is fixed to a rear end of the first movable rail 42, and is located at a front side of the guiding slot 412 of the stationary rail 41. The locking plate 421 defines a locking hole 427 in a middle portion thereof, and forms two blocking pieces 424 thereon. The two blocking pieces 424 are respectively located at the top and bottom sides of the locking hole 427, and cooperatively bounding a guiding slot 425. Each of the blocking pieces 424 includes a larger middle portion and two smaller end portions at the front and rear sides of the larger middle portion.

A locking plate 431 is fixed to a rear end of the second movable rail 43, and is located at a front side of the guiding slot 425 of the first movable rail 42, i.e. the locking plate 421 of the first movable rail 42 is located between the guiding slot 412 of the stationary rail 41 and the locking plate 431 of the second movable rail 43. The locking plate 431 defines a locking hole 435 in a middle portion thereof, and forms two blocking pieces 432 thereon. The two blocking pieces 432 are respectively located at the top and bottom sides of the locking hole 435, and cooperatively bounding a guiding slot 433. Each of the blocking pieces 432 includes a larger middle portion and two smaller end portions at the front and rear sides of the larger middle portion.

Referring back to FIG. 2, the arm assembly 10 includes a foldable main body 101, and a first fixing member 14 and a second fixing member 15 pivotally connected to two ends of the main body 101, respectively. The main body 101 includes a first arm segment 11, a second arm segment 12 and a third arm segment 13. Each of the first, the second and the third arm segments 11, 12, 13 is an elongated frame, and each defines a cable receiving passage 111, 121, 131 therein, for receiving and managing the cables of the electronic device.

The first arm segment 11 has a first end 112 and an opposite second end 113. The third arm segment 13 has a first end 132 and an opposite second end 133. Two ends of the second arm segment 12 are pivotally connected to the second end 113 of the first arm segment 11 and the first end 132 of the third arm segment 13, respectively. Both a length of the second arm segment 12 and a length of the third arm segment 13 are shorter than the length of the first arm segment 11. The sum of the lengths of the second and the third arm segments 12, 13 is substantially equal to the length of the first arm segment 11.

The first arm segment 11 forms two first blocking buttons 114 at the top and bottom sides of the second end 113 thereof. Each first blocking button 114 includes a neck 1141 connected to the first arm segment 11 and a head 1142 at a tail end of the neck 1141. The second arm segment 12 forms two second blocking buttons 122 at the top and bottom sides of an end thereof connected to the first arm segment 11. Each second blocking button 122 includes a neck 1221 connected to the second arm segment 12 and a head 1222 at a tail end of the neck 1221.

The first fixing member 14 includes a locking piece 141 and a connecting piece 142. The locking piece 141 defines a through hole 143 therein. A locking button 144 is inserted in the through hole 143 of the locking piece 141. Two ends of the connecting piece 142 are pivotally connected to the first end 112 of the first arm segment 11 and the locking piece 141, respectively.

The second fixing member 15 includes a locking piece 151 and a connecting piece 152. The locking piece 151 defines a through hole 153 therein. A locking button 154 is inserted in the through hole 153 of the locking piece 151. Two ends of the connecting piece 152 are pivotally connected to the second end 133 of the third arm segment 13 and the locking piece 151, respectively.

The supporting member 20 includes an elongated supporting arm 21, and two locking pieces 22 at two ends of the supporting arm 21. Each locking piece 22 defines a through hole 221 therein. A locking button 23 is inserted in the through hole 221 of the locking piece 22.

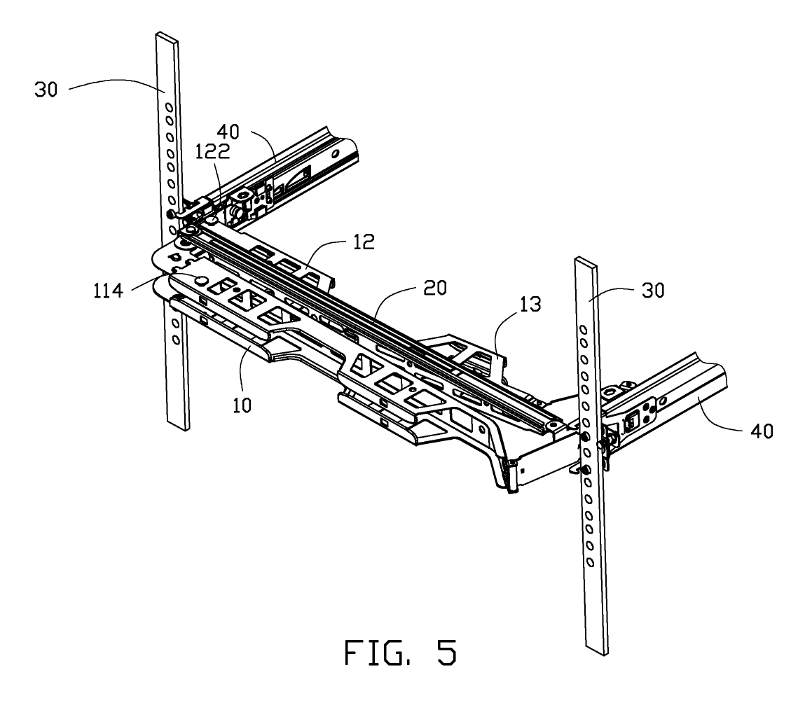

Referring to FIGS. 1 and 4-5, in assembling the cable management structure 100 to the two slide assemblies 40, two locking pieces 22 of the supporting member 20 are inserted into the guiding slots 425 of the first movable rails 42 of the two slide assemblies 40, with the through holes 221 of the locking pieces 22 respectively aligned with the locking holes 427 of the first movable rails 42 of the two slide assemblies 40. Then the locking buttons 23 are pressed into the locking holes 427 of the first movable rails 42 to mount the supporting member 20 to the first movable rails 42 of the two slide assemblies 40.

The locking piece 141 of the first fixing member 14 is inserted into the guiding slot 412 of the stationary rail 41 of the left slide assembly 40, with the through hole 143 of the locking piece 141 aligned with the locking hole 414 of the stationary rail 41 of the left slide assembly 40. Then the locking button 144 is pressed into the locking hole 414 of the stationary rail 41 of the left slide assembly 40 to mount the locking piece 141 of the first fixing member 14 to the stationary rail 41 of the left slide assembly 40. Thus a rear end of the main body 101 (i.e., the first end 112 of the first arm segment 11) is pivotally connected to the rear end of the stationary rail 41 of the left slide assembly 40.

The locking piece 151 of the second fixing member 15 is inserted into the guiding slot 433 of the second movable rail 43 of the left slide assembly 40, with the through hole 153 of the locking piece 151 aligned with the locking hole 435 of the second movable rail 43 of the left slide assembly 40. Then the locking button 154 is pressed into the locking hole 435 of the second movable rail 43 of the left slide assembly 40 to mount the locking piece 151 of the second fixing member 15 to the second movable rail 43 of the left slide assembly 40. Thus a front end of the main body 101 (i.e., the second end 133 of the third arm segment 13) is pivotally connected to the rear end of the second movable rail 43 of the left slide assembly 40.

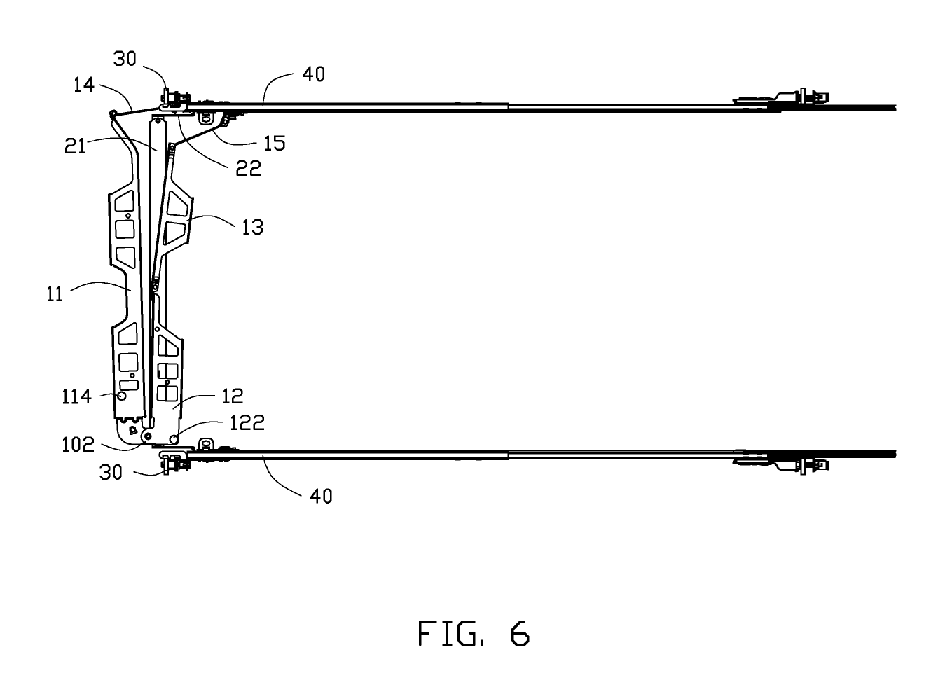

Referring to FIG. 6, a rotatable joint 102 of the first arm segment 11 and the second arm segment 12 is raised up, thereby allowing the second blocking button 122 at the bottom side of the second arm segment 12 to cross the supporting member 20. Thus the supporting member 20 is restricted between the first blocking button 114 at the bottom side of the first arm segment 11 and the second blocking button 122 at the bottom side of the second arm segment 12, and keeping the rotatable joint 102 of the first arm segment 11 and the second arm segment 12 on the supporting arm 21 of the supporting member 20.

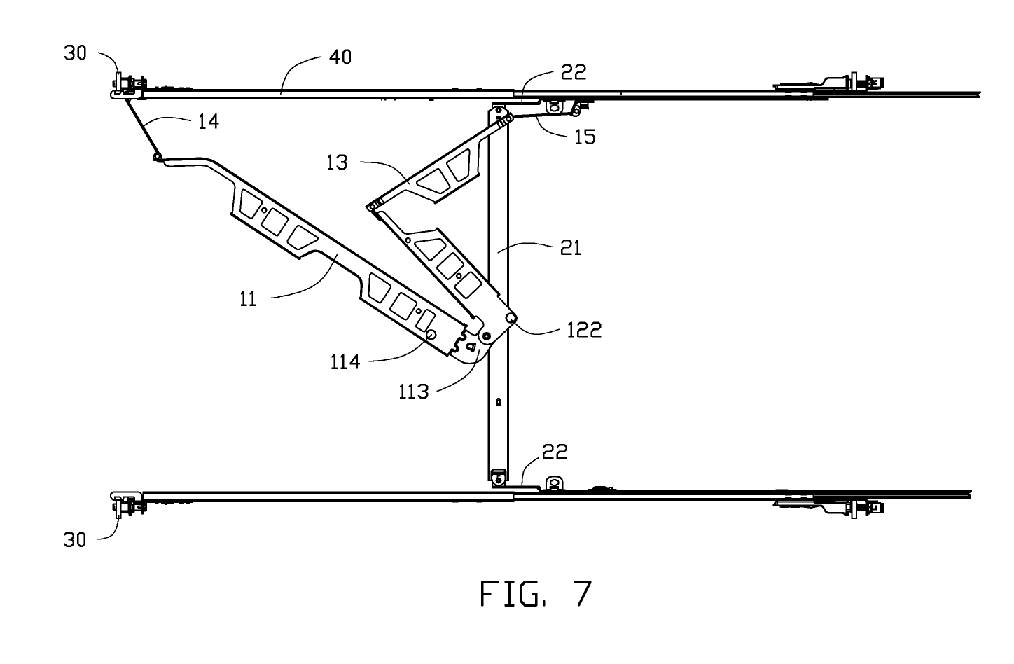

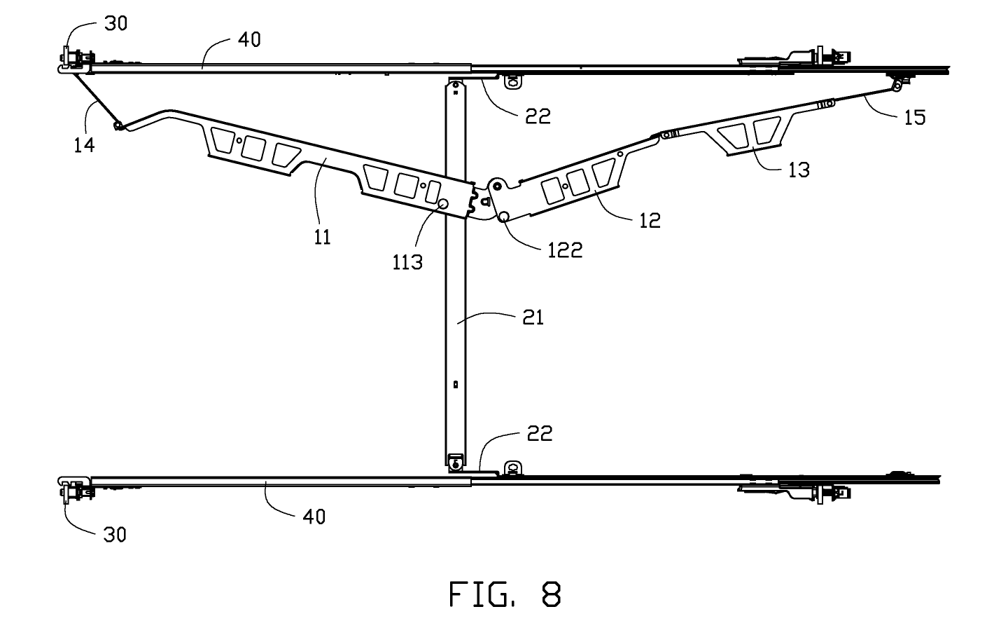

Referring also to FIGS. 7-8, in use, by pulling the first movable rails 42 and the second movable rails 43 of the two slide assemblies 40 forward, the supporting member 20 moves forward with the first movable rails 42 relative to the stationary rails 41 of the two slide assemblies 40, and driving the rotatable joint 102 of the first arm segment 11 and the second arm segment 12 to move forward with the supporting member 20 and move along the supporting arm 21 of the supporting member 20 towards the left slide assembly 40. Simultaneously, the second fixing member 15 moves forward with the second movable rail 43 of the left slide assembly 40 relative to the stationary rail 41, and driving the second end 133 of the third arm segment 13 to move forward with the second fixing member 15.

After the supporting member 20 has moved forward a predetermined distance, the first movable rails 42 of the two slide assemblies 40 are stopped at middle portions of the two slide assemblies 40 by a plurality of latching mechanisms (not shown) disposed in the two slide assemblies 40 (see in FIG. 7). The second movable rail 43 of the left slide assembly 40 continues on moving forward relative to the stationary rail 41 of the left slide assembly 40, driving the second end 133 of the third arm segment 13 to move forward with the second fixing member 15, and driving the rotatable joint 102 of the first arm segment 11 and the second arm segment 12 to move along on the supporting arm 21 of the supporting member 20 towards the left slide assembly 40 until the main body 101 is fully spread open (see in FIG. 8). A folding process of the cable management structure 100 is performed in reverse order to the spreading open process described above.

In the rack apparatus, two ends of the supporting member 20 are pivotally connected to the first movable portions (i.e., the first movable rails 42) of two opposite slide assemblies 40, one end of the cable management structure 100 is pivotally connected to a stationary portion (i.e., the stationary rail 41) of the left slide assembly 40, and the other end of the cable management structure 100 is pivotally connected to a second movable portion (i.e., the second movable rail 43) of the left slide assembly 40. During the spreading open process and the folding process of the cable management structure 100, the rotatable joint 102 of the first arm segment 11 and the second arm segment 12 is located over and supported by the supporting member 20 at all times, thereby preventing the arm assembly 10 from sagging so as to negatively affect the operation of an adjacent electronic device thereunder. In the folding process of the cable management structure 100, the first blocking button 114 of the first arm segment 11 can prevent the first arm segment 11 from inadvertently crossing the supporting member 20 to hit an electronic device which is located at a front side of the cable management structure 100.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A cable management structure, adapted to engage a pair of opposite first and second slide assemblies, the cable management structure comprising:
a supporting member; and
an arm assembly comprising a foldable main body, and a first fixing member and a second fixing member pivotally connected to two ends of the main body, respectively;
wherein the arm assembly is mounted to the pair of opposite first and second slide assemblies, two ends of the supporting member being pivotally connected to a first movable portion of the first slide assembly and a first movable portion of the second slide assembly, respectively, the arm assembly is supported on the supporting member, one end of the main body of the arm assembly is pivotally connected to a stationary portion of the first slide assembly via the first fixing member, and the other end of the main body of the arm assembly is pivotally connected to a second movable portion of the first slide assembly via the second fixing member, the main body of the arm assembly being spreadable with the extension of the first slide assembly, the supporting member being slidable with the first movable portions of the first and the second slide assemblies and supporting a portion of the main body of the arm assembly thereon during the spreading open and folding processes of the main body of the arm assembly.

2. The cable management structure of claim 1, wherein the main body of the arm assembly comprises a first arm segment, a second arm segment and a third arm segment, the first arm segment having a first end pivotally connected to the first fixing member and an opposite second end, the third arm segment having a first end and an opposite second end pivotally connected to the second fixing member, two ends of the second arm segment being pivotally connected to the second end of the first arm segment and the first end of the third arm segment, respectively.

3. The cable management structure of claim 2, wherein a rotatable joint of the first arm segment and the second arm segment is supported on the supporting member during the spreading open and folding processes of the main body.

4. The cable management structure of claim 3, wherein the first arm segment forms a first blocking button at a bottom side of the second end thereof, the second arm segment forms a second blocking button at a bottom side of an end thereof connected to the first arm segment, and the supporting member is restricted between the first blocking button of the first arm segment and the second blocking button of the second arm segment.

5. The cable management structure of claim 4, wherein the first blocking button of the first arm segment comprises a neck connected to the first arm segment and a head at a tail end of the neck, and the second blocking button of the second arm segment comprises a neck connected to the second arm segment and a head at a tail end of the neck.

6. The cable management structure of claim 2, wherein both a length of the second arm segment and a length of the third arm segment are shorter than the length of the first arm segment.

7. The cable management structure of claim 6, wherein the sum of the lengths of the second and the third arm segments is substantially equal to the length of the first arm segment.

8. The cable management structure of claim 1, wherein the first fixing member comprises a locking piece and a connecting piece, two ends of the connecting piece of the first fixing member being pivotally connected to the main body of the arm assembly and the locking piece of the first fixing member, the second fixing member comprising a locking piece and a connecting piece, two ends of the connecting piece of the second fixing member being pivotally connected to the main body of the arm assembly and the locking piece of the second fixing member.

9. A rack apparatus, comprising:
a plurality of opposite first and second slide assemblies, each of the first and the second slide assemblies comprising a stationary rail, and a first movable rail and a second movable rail slidably received in the stationary rail; and
a cable management structure disposed between the first and the second slide assemblies, the cable management structure comprising:
a supporting member having two ends thereof pivotally connected to the first movable rails of the first and second slide assemblies, respectively; and
an arm assembly supported on the supporting member, the arm assembly comprising a foldable main body, and a first fixing member and a second fixing member pivotally connected to two ends of the main body, respectively, one end of the main body of the arm assembly being pivotally connected to the stationary rail of the first slide assembly via the first fixing member, the other end of the main body of the arm assembly being pivotally connected to the second movable rail of the first slide assembly via the second fixing member, the main body of the arm assembly being spreadable with the extension of the first slide assembly, the supporting member being slidable with the first movable rails of the first and the second slide assemblies and supporting a portion of the main body of the arm assembly thereon during the spreading open and folding processes of the main body of the arm assembly.

10. The rack apparatus of claim 9, wherein the main body of the arm assembly comprises a first arm segment, a second arm segment and a third arm segment, the first arm segment having a first end pivotally connected to the first fixing member and an opposite second end, the third arm segment having a first end and an opposite second end pivotally connected to the second fixing member, and two ends of the second arm segment is pivotally connected to the second end of the first arm segment and the first end of the third arm segment, respectively.

11. The rack apparatus of claim 10, wherein a rotatable joint of the first arm segment and the second arm segment is supported on the supporting member during the spreading open and folding processes of the main body.

12. The rack apparatus of claim 11, wherein the first arm segment forms a first blocking button at a bottom side of the second end thereof, the second arm segment forms a second blocking button at a bottom side of an end thereof connected to the first arm segment, and the supporting member is restricted between the first blocking button of the first arm segment and the second blocking button of the second arm segment.

13. The rack apparatus of claim 12, wherein the first blocking button of the first arm segment comprises a neck connected to the first arm segment and a head at a tail end of the neck, and the second blocking button of the second arm segment comprises a neck connected to the second arm segment and a head at a tail end of the neck.

14. The rack apparatus of claim 10, wherein both a length of the second arm segment and a length of the third arm segment are shorter than the length of the first arm segment.

15. The rack apparatus of claim 14, wherein the sum of the lengths of the second and the third arm segments is substantially equal to the length of the first arm segment.

16. The rack apparatus of claim 10, wherein the first fixing member comprises a locking piece mounted to the stationary rail of the first slide assembly and a connecting piece, two ends of the connecting piece of the first fixing member being pivotally connected to the first end of the first arm segment and the locking piece of the first fixing member.

17. The rack apparatus of claim 16, wherein the locking piece of the first fixing member defines a through hole therein, a locking button being inserted in the through hole of the locking piece, the stationary rail of the first slide assembly having two blocking pieces cooperatively bounding a guiding slot, the stationary rail of the first slide assembly defining a locking hole therein between the two blocking pieces, the locking piece of the first fixing member being inserted in the guiding slot of the stationary rail of the first slide assembly, and the locking button being latched in the locking hole of the stationary rail of the first slide assembly.

18. The rack apparatus of claim 10, wherein the second fixing member comprises a locking piece mounted to the second movable rail of the first slide assembly and a connecting piece, two ends of the connecting piece of the second fixing member being pivotally connected to the second end of the third arm segment and the locking piece of the second fixing member.

19. The rack apparatus of claim 18, wherein the locking piece of the second fixing member defines a through hole therein, a locking button being inserted in the through hole of the locking piece, the second movable rail of the first slide assembly having two blocking pieces cooperatively bounding a guiding slot, the second movable rail of the first slide assembly defining a locking hole therein between the two blocking pieces, the locking piece of the second fixing member being inserted in the guiding slot of the second movable rail of the first slide assembly, and the locking button being latched in the locking hole of the second movable rail of the first slide assembly.
